(19) United States
(12) Patent Application Publication
(10) Pub. No.: US 2015/0304954 A1
(43) Pub. Date: Oct. 22, 2015

(54) ON-BOARD UNIT, VEHICLE MANAGEMENT SYSTEM, RECORDING MEDIUM AND VEHICLE MANAGEMENT METHOD

(71) Applicant: MITSUBISHI HEAVY INDUSTRIES, LTD., Minato-ku, Tokyo (JP)

(72) Inventors: Takeshi KORENAGA, Tokyo (JP); Hisaji TAKEUCHI, Tokyo (JP); Ryota HIURA, Tokyo (JP); Tomohiro MURATA, Tokyo (JP); Takeshi NAGATA, Tokyo (JP); Hiromichi NAKAMOTO, Tokyo (JP); Seiki KATO, Tokyo (JP)

(73) Assignee: MITSUBISHI HEAVY INDUSTRIES, LTD., Minato-ku, Tokyo (JP)

(21) Appl. No.: 14/650,457

(22) PCT Filed: Dec. 11, 2013
(86) PCT No.: PCT/JP2013/083182

§ 371 Date: Jun. 8, 2015

(30) Foreign Application Priority Data
Dec. 14, 2012 (JP) 2012-274077

(51) Int. Cl. H04W 52/02; H04L 29/08; G08G 1/127

(52) U.S. Cl. CPC H04W 52/0254; G08G 1/127; H04L 67/12

(57) ABSTRACT

An on-board unit 1 mounted on a vehicle includes a GPS receiver 21 determining the location of the on-board unit 1, a radio communication interface 22 and a processing unit 25. The processing unit 25 is configured to generate vehicle location information indicating the location of the on-board unit 1 determined by the GPS receiver 21 after starting a normal operation and to transmit the vehicle location information to the external device with the radio communication interface 22. The processing unit 25 is configured to, when detecting a stop of the vehicle, transmit vehicle stop information indicating the stop of the vehicle to the external device with the radio communication interface 22 and to place the on-board unit 1 into a low power consumption state after the transmission of the vehicle stop information.

### TECHNICAL FIELD

The present invention relates to an on-board unit, vehicle management system, and vehicle management method, more particularly, to a technique for managing the locations of on-board units (that is, the locations of vehicles on which the on-board units are mounted).

### BACKGROUND ART

Recently, car sharing has been studied as means of transportation in smart communities and tourist resorts. The car sharing would be also advantageous for environmental protection, especially when electric vehicles are used as vehicles to be shared by users.

In car sharing, it is assumed that general-public users find and ride on vehicles offered for the car sharing on the street, and then drop them off at their desired destinations. Accordingly, the manager of the car sharing needs to comprehend where each vehicle is moving or stopped.

The inventors have been considering mounting on-board units on vehicles as a method of such management. A management center can comprehend the status of each vehicle by causing an on-board unit mounted on the vehicle to notify the location of the vehicle, which may be moving or stopped, to the management center.

One issue of the vehicle management with an on-board unit is that the power of the battery of a vehicle is consumed if the stop location is continuously notified to the management center with the on-board unit even after the vehicle is stopped. There is a need for managing a vehicle offered for car sharing with a reduced consumption of the power of the vehicle battery.

As a technique which may relate to the present invention, International Publication No. WO 2007/040119 A1 discloses an on-board unit which monitors a battery of the vehicle with a CPU thereof to determine whether to transmit data or not.

Furthermore, Japanese Patent Application Publication No. 2004-189027 A discloses a technique in which an on-board unit intermittently transmits location information of a vehicle with electric power fed from a battery of the vehicle, when the on-board unit detects a shutdown of the accessory power supply.

### CITATION LIST

### Patent Literature

[Patent Literature 1] International Publication No. WO 2007/040119 A1
[Patent Literature 2] Japanese Patent Application Publication No. 2004-189027 A

### SUMMARY OF THE INVENTION

Therefore, an objective of the present invention is to provide a technique for managing a vehicle with a power consumption of a battery of the vehicle reduced in a vehicle management system which uses an on-board unit to manage the vehicle.

Provided in one aspect of the present invention is an on-board unit to be mounted on a vehicle. The on-board unit includes a location determination section determining the location of the on-board unit, a processing unit; and a radio communication section having the function of performing radio communications with an external device. The processing unit is configured to generate vehicle location information indicating the location of the on-board unit determined by the location determination section and to transmit the vehicle location information to the external device with the radio communication section, after starting a normal operation. The processing unit is configured to, when detecting a stop of the vehicle, transmit vehicle stop information indicating the stop of the vehicle to the external device with the radio communication section and to place the on-board unit into a low power consumption state after the transmission of the vehicle stop information.

It is preferable that the processing unit is configured to detect the stop of the vehicle on the basis of the voltage level on an accessory power supply line of the vehicle.

In one embodiment, the processing unit is configured to, when confirmation completion information generated in response to the vehicle stop information is transmitted from the external device to the radio communication section, receive the confirmation completion information through the radio communication section. In this case, it is preferable that the processing unit is configured to place the on-board unit into the low power consumption state after the processing unit receives the confirmation completion information.

It is preferable that the processing unit retransmits the vehicle stop information to the external device by using the radio communication section, when not receiving the confirmation completion information within a predetermined time period after the transmission of the vehicle stop information. In this case, it is preferable that the processing unit retransmits the vehicle stop information again when the processing unit does not receive the confirmation completion information.

The on-board unit may further include a switch connected between the processing unit and a battery line receiving a power supply voltage from a battery of the vehicle, and the power supply voltage may be fed to the processing unit from the battery line via the switch during the normal operation. In this case, it is preferable that the processing unit places the on-board unit into the low power consumption state by placing the switch into the OFF-state after the transmission of the vehicle stop information.

Furthermore, the on-board unit may further include a switch connected between the processing unit and a battery line receiving a power supply voltage from a battery of the vehicle, which is placed into an ON-state when the voltage level on the accessory power supply line is driven to the power supply voltage, and the power supply voltage may start to be fed to the processing unit by the switch being placed into the ON-state. The processing unit starts the normal operation when the feeding of the power supply voltage thereto is started. In this case, it is preferable that the processing unit places the on-board unit into the low power consumption state by placing the switch into the OFF-state after the transmission of the vehicle stop information.

In another aspect of the present invention, an on-board unit to be mounted on a vehicle is provided. The on-board unit includes a location determination section determining a location of the on-board unit, a processing unit; and a radio communication section having the function of performing radio communications with an external device. The processing unit is configured to generate vehicle location information indicating the location of the on-board unit after starting a normal operation. The processing unit is configured to detect a stop of the vehicle on the basis of the voltage level of an accessory power supply line of the vehicle, to transmit vehicle stop information indicating the stop of the vehicle when detecting the stop of the vehicle, and to place the on-board unit into a low power consumption state after the transmission of the vehicle stop information.

In still another aspect of the present invention, a vehicle management system includes an on-board unit to be mounted on a vehicle and a host computer. The on-board unit includes: a location determination section determining a location of the on-board unit, a processing unit, and a radio communication section having the function of performing radio communications with the host computer. The processing unit is configured to generate vehicle location information indicating the location of the on-board unit determined by the location determination section after starting a normal operation and to transmit the vehicle location information to the host computer with the radio communication section. Upon reception of the vehicle location information, the host computer stores in a database the location of the on-board unit described in the vehicle location information. The processing unit is configured to, when detecting a stop of the vehicle, transmit vehicle stop information indicating the stop of the vehicle to the host computer with the radio communication section and to place the on-board unit into a low power consumption state after the transmission of the vehicle stop information. Upon reception of the vehicle stop information, the host computer stores in the database data indicating the stop of the vehicle.

When the host computer is configured to transmit confirmation completion information to the on-board unit when receiving the vehicle stop information, it is preferable that the processing unit of the on-board unit is configured to place the on-board unit into the low power consumption state after reception of the confirmation completion information via the radio communication section. The transmission of the confirmation completion information from the host computer to the on-board unit may be achieved via a relay station; alternatively, no relay station may be used depending on the communication method.

In still another aspect of the present invention, a program is provided which is to be executed by a processing unit of an on-board unit mounted on a vehicle. The program causes the processing unit to perform steps of: generating vehicle location information indicating a location of the on-board unit determined by a location determination section included in the on-board unit after the processing unit starts a normal operation to transmit the vehicle location information to an external device with a radio communication section included in the on-board unit; when detecting a stop of the vehicle, transmitting vehicle stop information indicating the stop of the vehicle to the external device with the radio communication section; and placing the on-board unit into a low power consumption state after the transmission of the vehicle stop information. The program may be recorded in a recording medium.

Provided in still another aspect of the present invention is a vehicle management method to be implemented in a vehicle management system including an on-board unit mounted on a vehicle and a host computer. The vehicle management method includes: by a processing unit included in the on-board unit, generating vehicle location information indicating a location of the on-board unit determined by a location determination section included in the on-board unit after the processing unit starts a normal operation to transmit the vehicle location information to the host computer; storing in a database of the host computer the location of the on-board unit described in the vehicle location information; detecting a stop of the vehicle; when detecting the stop of the vehicle, transmitting vehicle stop information indicating the stop of the vehicle to the host computer; placing the on-board unit into a low power consumption state after the transmission of the vehicle stop information; and in the host computer, storing data indicating the stop of the vehicle in the database in response to the vehicle stop information.

The present invention provides a technique for managing a vehicle with a reduced power consumption of a battery of the vehicle in a vehicle management system in which the vehicle is managed by using an on-board unit.

### BRIEF DESCRIPTION OF DRAWINGS

FIG. 1 is a schematic diagram illustrating the overall configuration of a vehicle management system in a first embodiment of the present invention;

FIG. 2 is a diagram illustrating an example of the electric system configuration of a vehicle in the present embodiment;

FIG. 3 is a block diagram illustrating an example of the configuration of an on-board unit in the present embodiment;

FIG. 4 is a block diagram illustrating an example of the configuration of a host computer;

FIG. 5 is a diagram conceptually illustrating an example of contents of an EV management database;

FIG. 6 is a timing chart illustrating the operation of the vehicle management system, especially the operation of the on-board unit, in the first embodiment;

FIG. 7 is a timing chart illustrating one example of the operation of the vehicle management system in a second embodiment;

FIG. 8 is a timing chart illustrating another example of the operation of the vehicle management system in the second embodiment;

FIG. 9 is a block diagram illustrating an example of the configuration of the on-board unit in a third embodiment; and

FIG. 10 is a timing chart illustrating the operation of the vehicle management system, especially the operation of the on-board unit, in the third embodiment;

### DESCRIPTION OF EMBODIMENTS

### First Embodiment

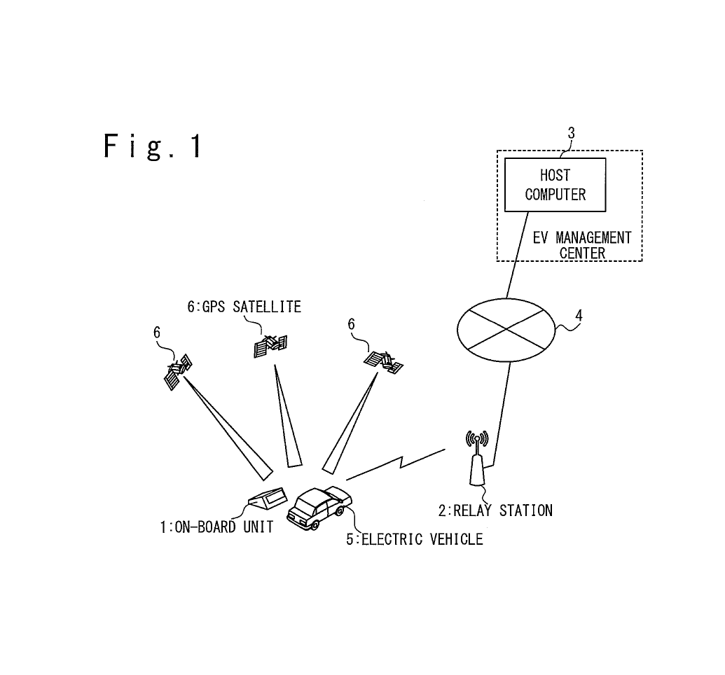

FIG. 1 is a conceptual diagram illustrating the overall configuration of a vehicle management system in a first embodiment of the present invention. The vehicle management system of the present embodiment is configured to manage electric vehicles 5 which are offered for car sharing. More specifically, the vehicle management system of the present embodiment includes an on-board unit 1 mounted on each electric vehicle 5, a relay station 2 which performs radio communications with the on-board unit 1 and a host computer 3 installed in an EV management center. The host computer 3 is connected with the relay station 2 via a network 4.

The on-board unit 1 and the host computer 3 can communicate with each other via the relay station 2 and the network 4. The on-board unit 1 has the function of measuring the location of the electric vehicle 5 by using electromagnetic wave received from a GPS satellite 6 and transmitting vehicle location information indicating the location of the electric vehicle 5 to the host computer 3. As described later, the vehicle location information is used to manage the electric vehicles 5.

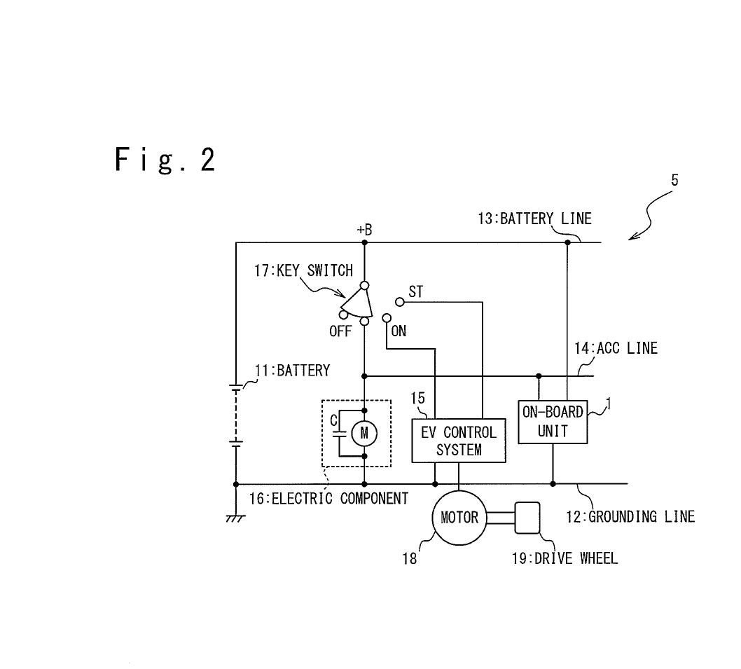

FIG. 2 is a diagram partially illustrating the electric system configuration of an electric vehicle 5. The electric system of the electric vehicle 5 includes a battery 11, a grounding line 12, a battery line 13, an accessory power supply line (hereinafter, referred to as “ACC line”) 14 and an EV control system 15. The battery 11 generates a predetermined power supply voltage (typically, 12V) and feeds the power supply voltage to the battery line 13. The negative terminal of the battery 11 is connected with the grounding line 12 and therefore the voltage between the grounding line 12 and the battery line 13 is equal to the power supply voltage. The ACC line 14 is a power line which feeds the power supply voltage to electric components 16 (such as power windows and electric retractable mirrors) and other accessory devices. The EV control system 15 is a control device which controls a motor 18 that drives drive wheels 19 and other devices used for driving, in response to operations of a throttle pedal and a transmission shift lever, to thereby control the driving of the electric vehicle 5. It should be noted that, in the present embodiment, the above-described on-board unit 1 is connected with both of the battery line 13 and the ACC line 14.

The key switch 17 is operated with a key of the electric vehicle 5 inserted thereinto and have four allowed positions: OFF position, ACC position, ON position (or IGN position) and ST position.

When the key switch 17 is set to the OFF position, the feeding of the power supply voltage to devices other than uninterruptible devices (devices directly receiving power from the battery line 13), including a clock and a keyless entry system (not shown) and the like, is stopped. In other words, the ACC line 14 is electrically disconnected from the battery line 13 when the key switch 17 is set to the OFF position.

When the key switch 17 is set to the ACC position, the ACC line 14 is connected with the battery line 13 through the key switch 17 and the power supply voltage is fed to the ACC line 14 from the battery line 13. This achieves feeding the power supply voltage to accessory devices from the ACC line 14. It should be noted however that the power supply voltage is not fed to the EV control system 15 from the battery line 13.

When the key switch 17 is set to the ON position, the power supply voltage is fed to all the devices necessary for driving the electric vehicle 5, including the EV control system 15, from the battery line 13 in addition to the accessory devices. More specifically, the power supply voltage is fed to the ACC line 14 by connecting the ACC line 14 with the battery line 13 through the key switch 17 and the power supply voltage is fed to the EV control system 15 through the key switch 17 from the battery line 13.

When the key switch 17 is set to the ST position, the power supply voltage is fed to all the devices necessary for driving the electric vehicle 5, and an operation for starting the electric vehicle 5 is further performed. When detecting that the key switch 17 is set to the ST position, the EV control system 15 performs the operation for starting the electric vehicle 5.

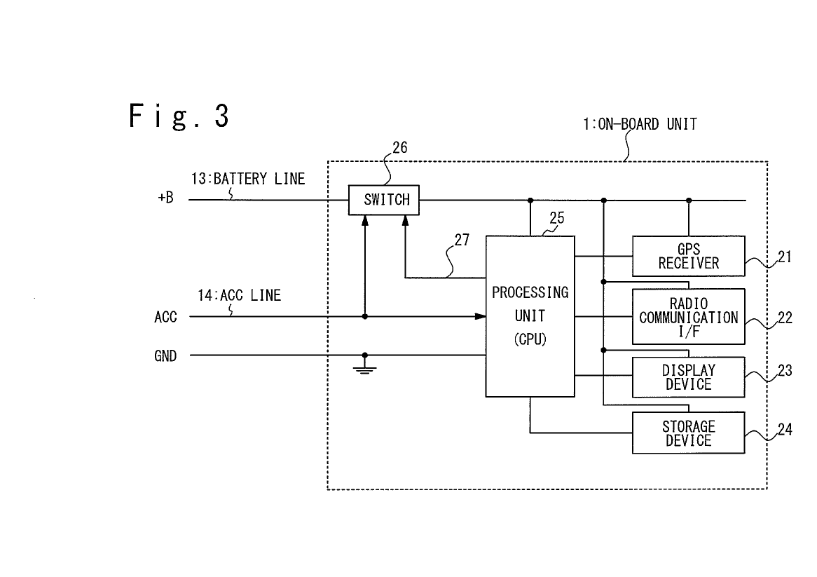

FIG. 3 is a block diagram schematically illustrating the configuration of the on-board unit 1. The on-board unit 1 includes a GPS receiver 21, a radio communication interface 22, a display device 23, a storage device 24, a processing unit 25 and an on-board unit switch 26. The GPS receiver 21 functions as a location determination section which receives the electromagnetic wave from the GPS satellite 6 and detects the location of the on-board unit 1 (that is, the location of the electric vehicle 5). The radio communication interface 22 functions as a radio communication section which performs radio communication with an external device, more specifically, the relay station 2. The display device 23 is used as a user interface which displays a variety of information for the user. The storage device 24 stores a variety of information necessary for the operation of the on-board unit 1.

The processing unit 25 performs a variety of data processing in the operation of the on-board unit 1. For example, the processing unit 25 generates vehicle location information indicating the location of the on-board unit 1 determined by the GPS receiver 21 and transmits the vehicle location information thus-generated to the host computer 3 with the radio communication interface 22.

In addition, as described later, the processing unit 25 also has the function of detecting a stop of the electric vehicle 5 by monitoring the ACC line 14. A return of the ACC line 14 to the ground level GND means that the key switch 17 is returned to the OFF position, and this implies that the electric vehicle 5 is stopped. Monitoring of the ACC line 14 allows reliably detecting a stop of the electric vehicle 5. When detecting a stop of the electric vehicle 5, the processing unit 25 generates vehicle stop information which indicates that the electric vehicle 5 is stopped and transmits the generated vehicle stop information to the relay station 2 via the radio communication interface 22.

The above-described operations of the processing unit 25 may be achieved by executing a program stored in the storage device 24 by the processing unit 25. A CPU (central processing unit) may be used as the processing unit 25, for example. The install of the program onto the storage device 24 may be achieved by using a recording medium which records the program.

The on-board unit switch 26 controls the feeding of the power supply voltage to the respective components of the on-board unit 1 (such as the GPS receiver 21, the radio communication interface 22, the display device 23, the storage device 24 and the processing unit 25) from the battery line 13. The on-board unit switch 26 is operated in response to the voltage level on the ACC line 14 and a control signal 27 received from the processing unit 25. In the present embodiment, the on-board unit switch 26 has the function of monitoring the voltage level on the ACC line 14 and is configured to be turned on in response to the voltage level. The on-board unit switch 26 is also configured to be turned off in response to the control signal 27 received from the processing unit 25.

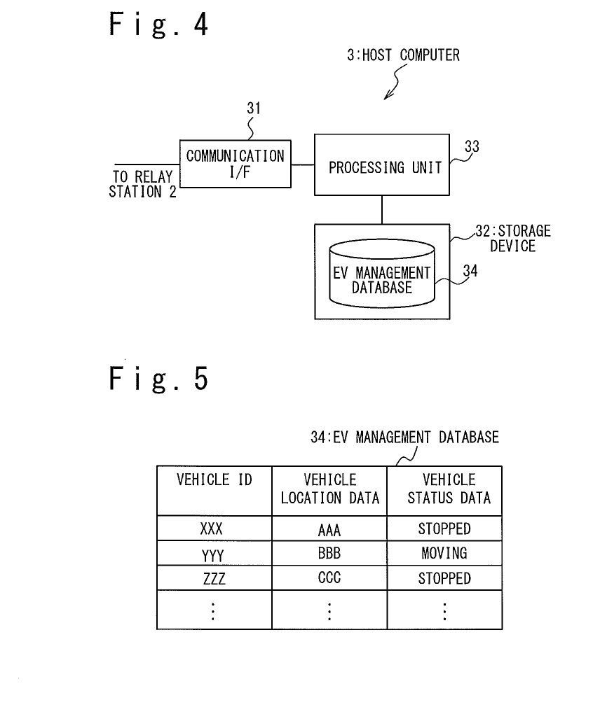

FIG. 4 is a block diagram illustrating the configuration of the host computer 3. The host computer 3 includes a communication interface 31, a storage device 32 and a processing unit 33. The communication interface 31 has the function of communicating with the relay station 2. The storage device 32 stores therein a variety of information necessary for the operation of the host computer 3, including an EV management database 34 for example. The EV management database 34 is used for managing the status of each electric vehicle 5 (details are described later). The processing unit 33 performs a variety of data processing in the host computer 3. For example, the processing unit 33 stores vehicle location information and vehicle stop information received from an on-board unit 1 into the EV management database 34. Such operation of the processing unit 33 may be achieved by executing a program stored in the storage device 32 by the processing unit 33. A CPU (central processing unit) may be used as the processing unit 33, for example.

FIG. 5 is a diagram conceptually illustrating the contents of the EV management database 34 stored in the storage device 32 of the host computer 3. Stored in the EV management database 34 are an vehicle ID which identifies each electric vehicle 5, vehicle location data indicating each electric vehicle 5, and vehicle status data indicating the status of each electric vehicle 5, in which database the vehicle ID, vehicle location data and vehicle status data are correlated with each other. The vehicle location data are generated on the basis of the vehicle location information transmitted from the on-board unit 1, and the vehicle status data are generated on the basis of the vehicle stop information transmitted from the on-board unit 1.

Next, a description is given of the operation of the vehicle management system, especially the operation of the on-board unit 1, in the present embodiment. Schematically, the on-board unit 1 of the present embodiment operates as follows: The on-board unit 1 transmits vehicle location information indicating the location of each electric vehicle 5 to the host computer 3 while the electric vehicle 5 is moving. The host computer 3 can comprehend the location of each electric vehicle 5 with the vehicle location information.

Additionally, the on-board unit 1 transmits to the host computer 3 vehicle stop information indicating that the electric vehicle 5 is stopped, when detecting that the electric vehicle 5 is stopped. The host computer 3 can comprehend that the electric vehicle 5 is stopped at the location indicated by the latest vehicle location information (or information of the location of the electric vehicle 5 included in the vehicle stop information) after receiving the vehicle stop information, even if the host computer 3 does not receive vehicle location information from the on-board unit 1.

After transmitting the vehicle stop information, the on-board unit 1 is switched to a state in which the power consumption is reduced compared with the normal operation. In the present embodiment, the on-board unit switch 26 is set to the OFF-state after the vehicle stop information is transmitted, and thereby the feeding of the power supply voltage to the respective components of the on-board unit 1 is stopped. This effectively suppresses the power consumption of the battery 11.

It should be noted that a stop of the electric vehicle 5 is detected on the basis of the voltage level on the ACC line 14 in the present embodiment. When the voltage level on the ACC line 14 is at or close to the ground level GND, this implies that the key switch 17 is set to the OFF position, that is, the electric vehicle 5 is stopped and it is likely that the electric vehicle 5 will remain stopped for a while. The host computer 3 can manage the location where the electric vehicle 5 is surely stopped by detecting the stop of the electric vehicle 5 on the basis of the voltage level on the ACC line 14 and transmitting to the host computer 3 the vehicle stop information indicating that the electric vehicle 5 is stopped. In the following, a description is given of details of the operation of the vehicle management system in the present embodiment.

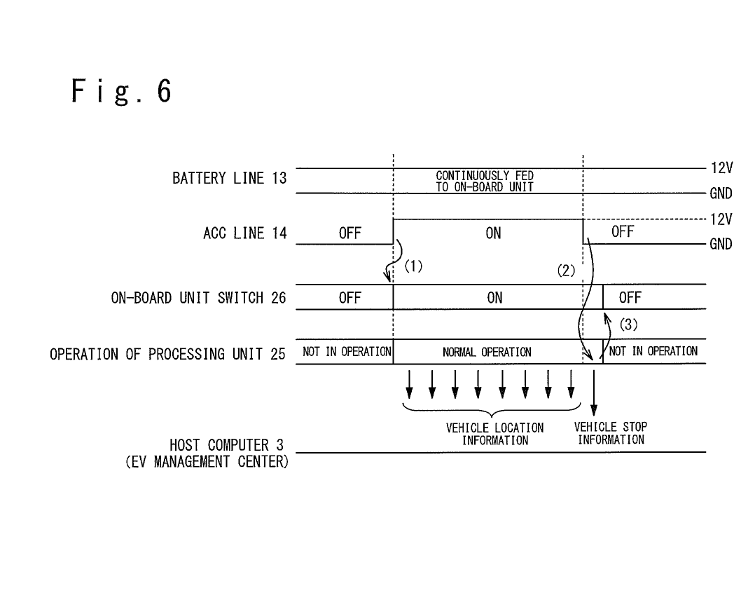

FIG. 6 is a timing chart illustrating the operations of the on-board unit 1 and the host computer 3 in the present embodiment. It is assumed that the key switch 17 is initially set to the OFF position. If the key switch 17 is set to the OFF position, this usually implies that the electric vehicle 5 remains stopped. When the electric vehicle 5 is parked in a parking lot, for example, the key switch 17 is usually set to the OFF position. When the key switch 17 is set to the OFF position, the ACC line 14 is electrically disconnected from the battery line 13 and the ACC line 14 is thereby set to the ground level GND.

In the present embodiment, a power supply voltage (typically, 12V) is continuously fed to the on-board unit 1 from the battery line 13. It is assumed however that the on-board unit switch 26 is initially set to the OFF-state and the power supply voltage is not fed to the respective components of the on-board unit 1. Accordingly, the processing unit 25 of the on-board unit 1 is placed in a state in which the processing unit 25 does not operate.

Discussed below is the case when the key switch 17 is then set to any of the ACC position, ON position and ST position. It should be noted that, when the key switch 17 is set to any of the ACC position, ON position and ST position, this usually implies that a user operation of the electric vehicle 5 or a driving of the electric vehicle 5 is about to be started. When the key switch 17 is set to any of the ACC position, ON position and ST position, the feeding of the power supply voltage from the battery line 13 to the ACC line 14 is started and the ACC line 14 is driven to the power supply voltage.

The on-board unit switch 26 is set to the ON-state in response to the ACC line 14 being driven to the power supply voltage (operation (1) in FIG. 6). In detail, when the voltage level on the ACC line 14 exceeds a predetermined voltage level (which is slightly lower than the power supply voltage), the on-board unit switch 26 determines that the ACC line 14 is driven to the power supply voltage and is placed into the ON-state. When the on-board unit switch 26 is placed into the ON-state, this initiates feeding of the power supply voltage to the respective components of the on-board unit 1 (including the GPS receiver 21, the radio communication interface 22, the display device 23, the storage device 24 and the processing unit 25, for example) to allow the respective components to start normal operations. It should be noted that the processing unit 25 also starts a normal operation at this moment.

After the feeding of the power supply voltage to the respective components of the on-board unit 1 is started, the respective components operate as follows: The GPS receiver 21 determines the location of the on-board unit 1 (that is, the location of the electric vehicle 5) on the basis of electromagnetic wave received from the GPS satellite 6, and transmits data indicating the determined location of the on-board unit 1 to the processing unit 25. The processing unit 25 transmits vehicle location information including the vehicle ID assigned to the electric vehicle 5 and data indicating the determined location of the on-board unit 1, to the relay station 2 via the radio communication interface 22. The vehicle location information may include information indicating that the electric vehicle 5 is placed into a movable state. The vehicle location information transmitted to the relay station 2 is further transmitted to the host computer 3 of the EV management center via the network 4.

Upon reception of the vehicle location information, the host computer 3 updates the EV management database 34. In detail, the host computer 3 stores the location of the electric vehicle 5 described in the vehicle location information as vehicle location data associated with the vehicle ID described in the vehicle location information. Additionally, the host computer 3 updates the vehicle status data associated with the vehicle ID described in the vehicle location information to data indicating that the electric vehicle 5 is placed in a movable state. In FIG. 5, for example, the data indicating that the electric vehicle 5 is placed in the movable state is illustrated as the legend “MOVING”.

Vehicle location information is repeatedly transmitted to the host computer 3 at desired time intervals as long as the ACC line 14 is kept at the power supply voltage (in other words, as long as the electric vehicle 5 remains in the movable state).

Discussed below is the case when the key switch 17 is then returned to the OFF position. When the key switch 17 is set to the OFF position, this usually implies that the user has stopped the electric vehicle 5 and finished the operation of the electric vehicle 5.

When the key switch 17 is returned to the OFF position, the ACC line 14 is electrically disconnected from the battery line 13 and accordingly the ACC line 14 is returned to the ground level GND. When detecting that the ACC line 14 is returned to the ground level GND, the processing unit 25 generates vehicle stop information including the vehicle ID assigned to the electric vehicle (operation (2) in FIG. 6).

In detail, when the voltage level on the ACC line 14 becomes lower than a predetermined voltage level (which is slightly higher than the ground level GND), the processing unit 25 determines that the ACC line 14 is returned to the ground level GND. When the ACC line 14 is returned to the ground level GND, this implies that the electric vehicle 5 is stopped. When detecting that the electric vehicle 5 is stopped on the basis of the voltage level on the ACC line 14, the processing unit 25 generate the vehicle stop information including the vehicle ID assigned to the electric vehicle 5, and transmits the generated vehicle stop information to the relay station 2 via the radio communication interface 22. The vehicle stop information may include the location of the electric vehicle 5 determined by the GPS receiver 21. The location of the electric vehicle 5 described in the vehicle stop information indicates the location where the electric vehicle 5 is stopped. The vehicle stop information transmitted to the relay station 2 is further transmitted to the host computer 3 of the EV management center via the network 4.

Upon reception of the vehicle stop information, the host computer 3 updates the EV management database 34. In detail, the host computer 3 updates the vehicle status data associated with the vehicle ID described in the vehicle stop information to data indicating that the electric vehicle 5 is placed in a state in which the electric vehicle 5 is stopped. In FIG. 5, for example, the data indicating that the electric vehicle 5 is placed in a state in which the electric vehicle 5 is stopped is illustrated as the legend “STOPPED”. Additionally, when the received vehicle stop information includes the location of the electric vehicle 5, the host computer 3 stores the location of the electric vehicle 5 described in the vehicle stop information as vehicle location data associated with the vehicle ID described in the vehicle stop information.

After transmitting the vehicle stop information to the host computer 3, the processing unit 25 places the on-board unit switch 26 into the OFF-state with the control signal 27. This places the on-board unit 1 into a state in which the power supply voltage is not fed to the respective components thereof, to stop the operations of the respective components of the on-board unit 1 thereafter. This effectively avoids the respective components of the on-board unit 1 consuming the electric power accumulated in the battery 11.

As described above, in the present embodiment, vehicle location information is repeatedly transmitted from the on-board unit 1 to the host computer 3 while the electric vehicle 5 is moving. This allows the host computer 3 to manage the location of the on-board unit 1, that is, the location of the electric vehicle 5. Furthermore, when a stop of the electric vehicle 5 is detected, vehicle stop information is transmitted from the on-board unit 1 to the host computer 3, and the on-board unit 1 is switched to a low power consumption state (in the present embodiment, a state in which the power supply voltage is not fed to the respective components of the on-board unit 1) after the vehicle stop information is transmitted to the host computer 3. This allows the host computer 3 to surely comprehend the location where the electric vehicle 5 is stopped, while the power consumption of the battery 11 is reduced in the electric vehicle 5.

### Second Embodiment

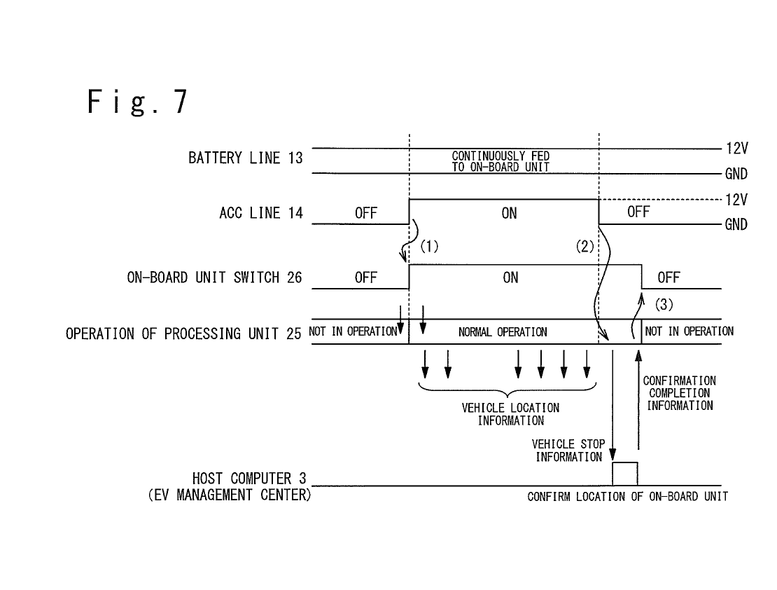

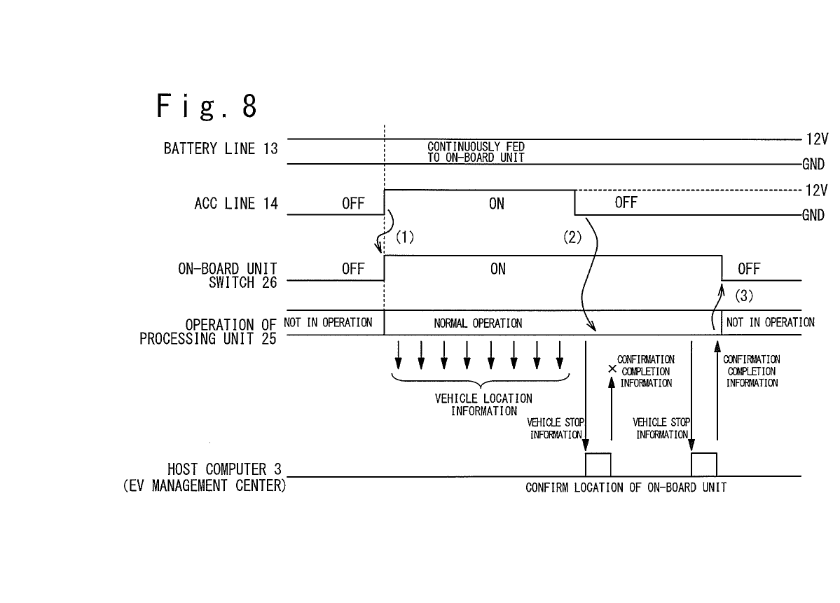

FIGS. 7 and 8 are timing charts illustrating the operations of the on-board unit 1 and the host computer 3 in a second embodiment. It should be noted that the configurations of the on-board unit 1 and the host computer 3 are same as those in the first embodiment.

Also in the second embodiment, the on-board unit switch 26 is set to the ON-state in response to the ACC line 14 being driven to the power supply voltage (operation (1) in FIG. 7) and the power supply voltage starts to be fed to the respective components of the on-board unit 1 (including, the GPS receiver 21, the radio communication interface 22, the display device 23, the storage device 24 and the processing unit 25, for example). This allows the respective components of the on-board unit 1 to start normal operations. Subsequently, the processing unit 25 transmits vehicle location information indicating the location of the on-board unit 1 (that is, the location of the electric vehicle 5) to the host computer 3 at desired time intervals. Furthermore, when a stop of the electric vehicle 5 is detected from the voltage level on the ACC line 14, vehicle stop information is transmitted from the on-board unit 1 to the host computer 3 (operation (2) in FIG. 7).

In the second embodiment, after the host computer 3 receives the vehicle stop information, the host computer 3 transmits confirmation completion information indicating that the host computer 3 has successfully received the vehicle stop information, to the on-board unit 1 via the network 4 and the relay station 2. After receiving the confirmation completion information, the processing unit 25 of the on-board unit 1 places the on-board unit switch 26 into the OFF-state with the control signal 27 (operation (3) in FIG. 7). As a result, the feeding of the power supply voltage to the respective components of the on-board unit 1 is stopped and the respective components of the on-board unit 1 stop operating. Such operation effectively avoids the respective components of the on-board unit 1 consuming the power accumulated in the battery 11.

The above-described operation improves the reliability of the management of the electric vehicle 5, since the operation of the on-board unit 1 is stopped after the reception of the vehicle stop information by the host computer 3 is confirmed.

As illustrated in FIG. 8, when the on-board unit 1 fails to receive the confirmation completion information due to a fault of the communication between the on-board unit 1 and the host computer 3, the processing unit 25 may retransmit the vehicle stop information. The fault of the communication between the on-board unit 1 and the host computer 3 may occur, for example, due to poor line conditions between the radio communication interface 22 and the relay station 2. FIG. 8 illustrates an operation in which the communication of the confirmation completion information from the host computer 3 to the on-board unit 1 has failed after the vehicle stop information has reached from the on-board unit 1 to the host computer 3. It should be noted that the on-board unit 1 fails to receive the confirmation completion information also in the case when the communication of the vehicle stop information from the on-board unit 1 to the host computer 3 has failed.

In one embodiment, the processing unit 25 of the on-board unit 1 retransmits the vehicle stop information to the host computer 3 when not receiving the confirmation completion information within a predetermined time period after transmitting the vehicle stop information. The vehicle stop information may be repeatedly retransmitted. In this case, an allowed maximum number of the transmissions may be determined, that is, the number of times of the retransmissions may be limited to or below a predetermined upper limit. Alternatively, the retransmissions may be repeated until a predetermined period has elapsed after the first transmission of the vehicle stop information. When the on-board unit 1 receives the confirmation completion information from the host computer 3 after the retransmission(s) of the vehicle stop information, the processing unit 25 places the on-board unit switch 26 into the OFF-state with the control signal 27.

In this operation, when the on-board unit 1 does not receive the confirmation completion information after the vehicle stop information are retransmitted the allowed maximum number of times or when the predetermined period has elapsed after the first transmission of the vehicle stop information, the on-board unit 1 may issue a warning. The issuance of the warning may be achieved by displaying a specific message (like a message saying “move to a place where radio wave conditions are good”) on the display device 23 of the on-board unit 1 and generating message sound with a speaker provided for the on-board unit 1. Such operation allows prompting the user to move the electric vehicle 5 to a place where radio wave conditions are good, when the vehicle stop information is not successfully transmitted from the on-board unit 1 to the host computer 3. This contributes a reliable management of the electric vehicle 5.

### Third Embodiment

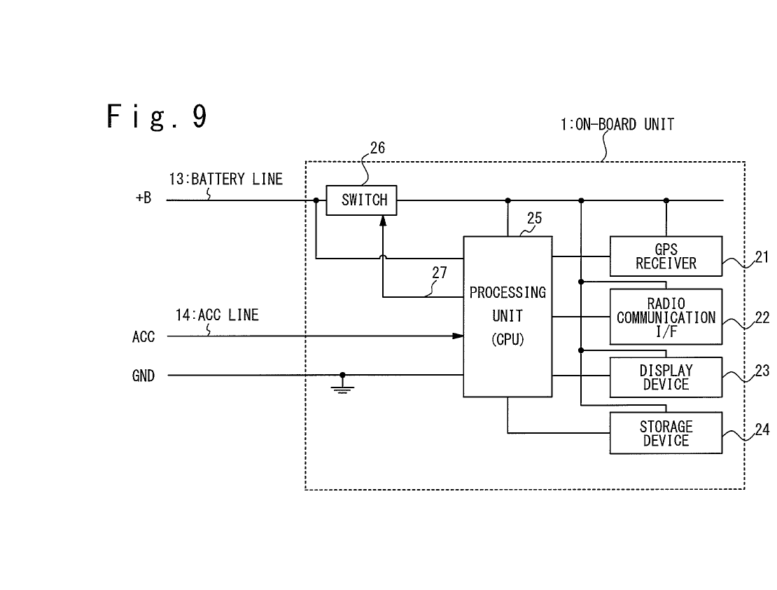

FIG. 9 illustrates an example of the configuration of the on-board unit 1 in a third embodiment. In the first and second embodiments described above, the on-board unit 1 is switched to a low power consumption state by placing the on-board unit switch 26 into the OFF-state after transmitting the vehicle stop information or receiving the confirmation completion information. In the third embodiment, in contrary, the operation of the on-board unit 1 is not completely stopped in the low power consumption state. In the present embodiment, the on-board unit 1 is switched to the low power consumption state by placing the processing unit 25 into a sleep mode (that is, an operation mode in which the power consumption is reduced) after transmitting the vehicle stop information or receiving the confirmation completion information.

As illustrated in FIG. 9, the configuration of the on-board unit 1 of the third embodiment is similar to that of the on-board unit 1 of the first and second embodiment; the difference is as follows: More specifically, the power supply voltage is continuously fed to the processing unit 25 from the battery line 13 in the third embodiment. The on-board unit switch 26 does not have the function of monitoring the voltage level on the ACC line 14. The on-board unit switch 26 operates in response to the control signal 27 received from the processing unit 25. The processing unit 25 instead has the function of monitoring the voltage level on the ACC line 14 even when the processing unit 25 is placed into the sleep mode. The processing unit 25 turns on and off the on-board unit switch 26 in response to the voltage level on the ACC line 14. The turn-on-and-off of the on-board unit switch 26 is achieved with the control signal 27.

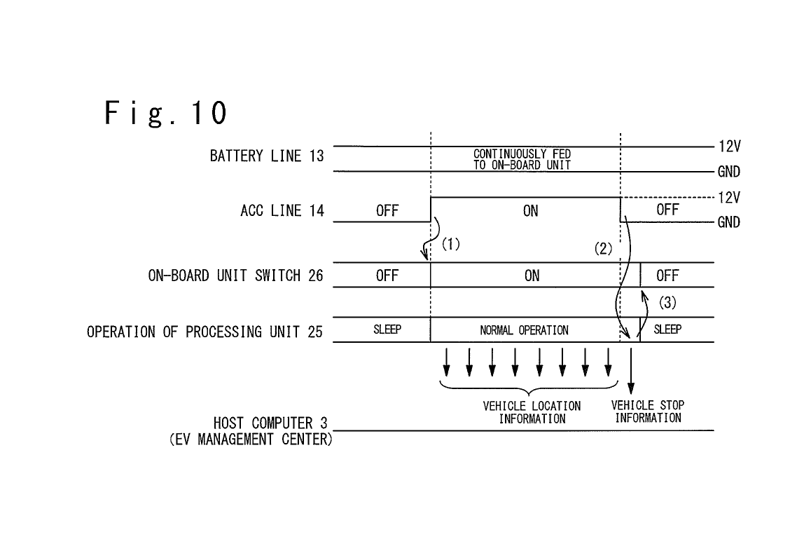

FIG. 10 is a timing chart illustrating the operation of the on-board unit 1 in the third embodiment. It is assumed that the key switch 17 is initially set to the OFF position. When the key switch 17 is set to the OFF position, the ACC line 14 is electrically disconnected from the battery line 13 and the ACC line 14 is thereby set to the ground level GND.

Meanwhile, the on-board unit 1 receives a power supply voltage (typically, 12V) from the battery line 13. Note that it is assumed that the on-board unit switch 26 is initially set to the OFF-state. In other words, it is assumed that the power supply voltage is fed only to the processing unit 25, not fed to any other components of the on-board unit 1. The processing unit 25 is initially placed in the sleep mode, operating with reduced power consumption.

Discussed below is the case when the key switch 17 is then set to any of the ACC position, ON position and ST position. It should be noted that, when the key switch 17 is set to any of the ACC position, ON position and ST position, this usually implies that the electric vehicle 5 is being operated or driven by the user. When the key switch 17 is set to any of the ACC position, ON position and ST position, the feeding of the power supply voltage from the battery line 13 to the ACC line 14 is started and the ACC line 14 is driven to the power supply voltage.

When detecting that the ACC line 14 is driven to the power supply voltage, the processing unit 25 starts the normal operation and places the on-board unit switch 26 into the ON-state with the control signal 27 (operation (1) in FIG. 10). When the on-board unit switch 26 is placed into the ON-state, the power supply voltage starts to be fed to components of the on-board unit 1 other than the processing unit 25 (for example, the GPS receiver 21, the radio communication interface 22, the display device 23 and the storage device 24), and the respective components starts normal operations.

After starting the normal operations, the respective components of the on-board unit 1 operate as follows: The GPS receiver 21 determines the location of the on-board unit 1 (that is, the location of the electric vehicle 5) on the basis of electromagnetic wave received from the GPS satellite 6, and transmits data indicating the determined location of the on-board unit 1 to the processing unit 25. The processing unit 25 transmits vehicle location information including the vehicle ID assigned to the electric vehicle 5 and data indicating the determined location of the on-board unit 1, to the relay station 2 via the radio communication interface 22. The vehicle location information may include information indicating that the electric vehicle 5 is placed into a movable state. The vehicle location information transmitted to the relay station 2 is further transmitted to the host computer 3 of the EV management center via the network 4.

Upon reception of the vehicle location information, the host computer 3 updates the EV management database 34. In detail, the host computer 3 stores the location of the electric vehicle 5 described in the vehicle location information as vehicle location data associated with the vehicle ID described in the vehicle location information. Additionally, the host computer 3 updates the vehicle status data associated with the vehicle ID described in the vehicle location information to data indicating that the electric vehicle 5 is placed in a movable state.

Vehicle location information is repeatedly transmitted to the host computer 3 at desired time intervals as long as the ACC line 14 is kept at the power supply voltage (in other words, as long as the electric vehicle 5 remains in the movable state).

Discussed below is the case when the key switch 17 is then returned to the OFF position. When the key switch 17 is returned to the OFF position, the ACC line 14 is electrically disconnected from the battery line 13 and accordingly the ACC line 14 is returned to the ground level GND. When detecting that the ACC line 14 is returned to the ground level GND, the processing unit 25 generates vehicle stop information including the vehicle ID assigned to the electric vehicle 5 and transmits the generated vehicle stop information to the relay station 2 via the radio communication interface 22 (operation (2) in FIG. 10). The vehicle stop information may include the location of the electric vehicle 5 determined by the GPS receiver 21. The location of the electric vehicle 5 described in the vehicle stop information indicates the location where the electric vehicle 5 is stopped. The vehicle stop information transmitted to the relay station 2 is further transmitted to the host computer 3 of the EV management center via the network 4.

Upon reception of the vehicle stop information, the host computer 3 updates the EV management database 34. In detail, the host computer 3 updates the vehicle status data associated with the vehicle ID described in the vehicle stop information to data indicating that the electric vehicle 5 is placed in a state in which the electric vehicle 5 is stopped. Additionally, when the received vehicle stop information includes the location of the electric vehicle 5, the host computer 3 stores the location of the electric vehicle 5 described in the vehicle stop information as vehicle location data associated with the vehicle ID described in the vehicle stop information.

After transmitting the vehicle stop information to the host computer 3, the processing unit 25 places the on-board unit switch 26 into the OFF-state with the control signal 27. This causes the on-board unit 1 to be placed into a state in which the power supply voltage fails to be fed to the respective components of the on-board unit 1 other than the processing unit 25. Additionally, the processing unit 25 is switched to the sleep mode. Such operation suppresses consumption of the electric power accumulated in the battery 11, by the respective components of the on-board unit 1.

Although the above-described third embodiment recites that the processing unit 25 is switched to the sleep mode after transmitting the vehicle stop information, other components may be switched into a sleep mode, when they also have a sleep mode.

Although FIG. 10 illustrates an embodiment in which confirmation completion information is not transmitted from the host computer 3 to the on-board unit 1, the processing unit 25 may place the on-board unit switch 26 into the OFF-state and be switched to the sleep mode after the on-board unit 1 has received the confirmation completion information, similarly to the operations illustrated in FIGS. 7 and 8.

Although a stop of the electric vehicle 5 is detected on the basis of the voltage level on the ACC line 14 in the above-described first to third embodiment, a stop of the electric vehicle 5 may be detected with any other means. For example, the processing unit 25 may determine that the electric vehicle 5 is stopped when the location of the electric vehicle 5 determined by the GPS receiver 21 has been unchanged for a predetermined period of time. A stop of the electric vehicle 5 may be detected on the basis of operation statuses of respective devices which usually perform specific operations when the electric vehicle 5 is stopped (for example, the position to which the key switch 17 is set, the position of the shift lever, the position of the throttle pedal, the in-operation or out-of-operation of the parking brake). It should be however noted that the configuration in which a stop of the electric vehicle 5 is detected on the basis of the voltage level on the ACC line 14 as in the above-described embodiments is preferable in terms of simple and reliable detection of the stop of the electric vehicle 5.

Although various embodiments of the present invention are described above, the present invention is not limited to the above-described embodiments. It would be apparent to a person skilled in the art that the present invention may be implemented with various modifications.

For example, it should be noted that, although the first to third embodiments described above recite a vehicle management system for managing electric vehicles, the present invention is applicable to any kinds of vehicles, including electric vehicles, since the issue of the power consumption of the battery also applies to any kinds of vehicles. Also in this case, the on-board unit 1 is connected to both of the battery line 13 and the ACC line 14.

1. An on-board unit to be mounted on a vehicle, the unit comprising:
a location determination section determining a location of the on-board unit;
a processing unit; and
a radio communication section having a function of performing radio communications with an external device,
wherein the processing unit is configured to generate vehicle location information indicating the location of the on-board unit determined by the location determination section and to transmit the vehicle location information to the external device with the radio communication section, after starting a normal operation and
wherein the processing unit is configured to, when detecting a stop of the vehicle, transmit vehicle stop information indicating the stop of the vehicle to the external device with the radio communication section and to place the on-board unit into a low power consumption state after the transmission of the vehicle stop information.

2. The on-board unit according to claim 1, wherein the processing unit is configured to detect the stop of the vehicle based on a voltage level on an accessory power supply line of the vehicle.

3. The on-board unit according to claim 1, wherein the processing unit is configured to, when confirmation completion information generated in response to the vehicle stop information is transmitted from the external device to the radio communication section, receive the confirmation completion information through the radio communication section and to place the on-board unit into the low power consumption state after the processing unit receives the confirmation completion information.

4. The on-board unit according to claim 3, wherein the processing unit retransmits the vehicle stop information to the external device by using the radio communication section, when not receiving the confirmation completion information within a predetermined time period after the transmission of the vehicle stop information.

5. The on-board unit according to claim 4, wherein the processing unit retransmits the vehicle stop information again when the processing unit does not receive the confirmation completion information.

6. The on-board unit according to claim 1, further comprising:
a switch connected between the processing unit and a battery line receiving a power supply voltage from a battery of the vehicle,
wherein the power supply voltage is fed to the processing unit from the battery line via the switch, while the normal operation is performed, and
wherein the processing unit places the on-board unit into the low power consumption state by placing the switch into an OFF-state after the transmission of the vehicle stop information.

7. The on-board unit according to claim 2, further comprising:
a switch connected between the processing unit and a battery line receiving a power supply voltage from a battery of the vehicle,
wherein the switch is placed into an ON-state when the voltage level on the accessory power supply line is driven to the power supply voltage, and the power supply voltage starts to be fed to the processing unit by the switch being placed into the ON-state,
wherein the processing unit starts the normal operation when the feeding of the power supply voltage thereto is started, and
wherein the processing unit places the on-board unit into the low power consumption state by placing the switch into an OFF-state after the transmission of the vehicle stop information.

8. An on-board unit to be mounted on a vehicle, the unit comprising:
a location determination section determining a location of the on-board unit;
a processing unit; and
a radio communication section having a function of performing radio communications with an external device,
wherein the processing unit is configured to generate vehicle location information indicating the location of the on-board unit after starting a normal operation, and
wherein the processing unit is configured to detect a stop of the vehicle based on a voltage level of an accessory power supply line of the vehicle, to transmit vehicle stop information indicating the stop of the vehicle when detecting the stop of the vehicle, and to place the on-board unit into a low power consumption state after the transmission of the vehicle stop information.

9. A vehicle management system, comprising:
an on-board unit to be mounted on a vehicle; and
a host computer,
wherein the on-board unit includes:
a location determination section determining a location of the on-board unit;
a processing unit; and
a radio communication section having a function of performing radio communications with the host computer,
wherein the processing unit is configured to generate vehicle location information indicating the location of the on-board unit determined by the location determination section after starting a normal operation and to transmit the vehicle location information to the host computer with the radio communication section, and
wherein, upon reception of the vehicle location information, the host computer stores in a database the location of the on-board unit described in the vehicle location information,
wherein the processing unit is configured to, when detecting a stop of the vehicle, transmit vehicle stop information indicating the stop of the vehicle to the host computer with the radio communication section and to place the on-board unit into a low power consumption state after the transmission of the vehicle stop information, and
wherein, upon reception of the vehicle stop information, the host computer stores in the database data indicating the stop of the vehicle.

10. The vehicle management system according to claim 9, wherein the host computer transmits confirmation completion information to the on-board unit when receiving the vehicle stop information, and
wherein the processing unit of the on-board unit is configured to place the on-board unit into the low power consumption state after reception of the confirmation completion information via the radio communication section.

11. The vehicle management system according to claim 9, wherein the processing unit is configured to detect the stop of the vehicle based on a voltage level on an accessory power supply line of the vehicle.

12. A recording medium recording a program which causes a processing unit of an on-board unit mounted on a vehicle to perform steps of:
generating vehicle location information indicating a location of the on-board unit determined by a location determination section included in the on-board unit after the processing unit starts a normal operation to transmit the vehicle location information to an external device with a radio communication section included in the on-board unit; and
when detecting a stop of the vehicle, transmitting vehicle stop information indicating the stop of the vehicle to the external device with the radio communication section; and
placing the on-board unit into a low power consumption state after the transmission of the vehicle stop information.

13. A vehicle management method to be implemented in a vehicle management system including an on-board unit mounted on a vehicle and a host computer, the method comprising:
by a processing unit included in the on-board unit, generating vehicle location information indicating a location of the on-board unit determined by a location determination section included in the on-board unit after the processing unit starts a normal operation to transmit the vehicle location information to the host computer;
storing in a database of the host computer the location of the on-board unit described in the vehicle location information;
detecting a stop of the vehicle;
when detecting the stop of the vehicle, transmitting vehicle stop information indicating the stop of the vehicle to the host computer;
placing the on-board unit into a low power consumption state after the transmission of the vehicle stop information; and
in the host computer, storing data indicating the stop of the vehicle in the database in response to the vehicle stop information.
